(19) United States
(12) Patent Application Publication
(10) Pub. No.: US 2025/0061739 A1
(43) Pub. Date: Feb. 20, 2025

(54) FINGERPRINT SENSING DEVICE AND ELECTRONIC APPARATUS

(71) Applicant: Egis Technology Inc., Hsinchu City (TW)

(72) Inventors: Chen-Chih Fan, Hsinchu City (TW); Bruce C. S. Chou, Hsinchu City (TW)

(73) Assignee: Egis Technology Inc., Hsinchu City (TW)

(21) Appl. No.: 18/765,360

(22) Filed: Jul. 8, 2024

Related U.S. Application Data
(60) Provisional application No. 63/532,883, filed on Aug. 15, 2023.
(60) Provisional application No. 63/542,288, filed on Oct. 3, 2023.

(30) Foreign Application Priority Data
Dec. 14, 2023 (CN) 202323427430.5

(51) Int. Cl. G06V 40/13; G06V 10/12

(52) U.S. Cl. CPC G06V 40/1306; G06V 10/12

(57) ABSTRACT

The disclosure relates to a fingerprint sensing device and an electronic apparatus including the fingerprint sensing device. In one aspect, the fingerprint sensing device includes: a substrate, including a first surface and a second surface that are opposite to each other; a piezoelectric transducer, disposed on the first surface of the substrate; and a circuit board, disposed opposite to the piezoelectric transducer in a short side direction of the substrate. The circuit board is electrically connected to the first surface of the substrate by wire bonding, and a distance between the circuit board and the piezoelectric transducer is less than 2 mm. According to the disclosure, a reduction in the size of the fingerprint sensing device can be achieved.

### CROSS-REFERENCE TO RELATED APPLICATION

This application claims the priority benefit of U.S. provisional application Ser. No. 63/532,883, filed on Aug. 15, 2023, U.S. provisional application Ser. No. 63/542,288, filed on Oct. 3, 2023, and China application serial no. 202323427430.5, filed on Dec. 14, 2023. The entirety of each of the above-mentioned patent applications is hereby incorporated by reference herein and made a part of this specification.

### BACKGROUND

### Technical Field

The disclosure relates to the technical field of fingerprint recognition, and particularly relates to a fingerprint sensing device and an electronic apparatus including the fingerprint sensing device.

### Description of Related Art

Fingerprint recognition technology is a technology that uses the uniqueness of individual fingerprints for identity verification. It has been widely used in many fields involving identity verification, such as enabling of the access rights of electronic apparatuses (e.g., mobile phones, etc.), and identity recognition of consumer payments. As one of the main fingerprint recognition technologies, ultrasonic fingerprint recognition technology uses ultrasonic waves to detect the concave and convex textures of the fingerprints. It has the advantages of high recognition accuracy and is not easily affected by dirt on the fingers. Therefore, fingerprint sensing devices applying the ultrasonic fingerprint recognition technology have been increasingly used in electronic apparatuses.

However, the internal space of the electronic apparatuses is limited. Especially as electronic apparatuses such as mobile phones and tablets are designed to become increasingly thinner, the side frames of the electronic apparatuses need to be narrowed, causing the internal space of the electronic apparatuses to be further compressed. This brings challenges to the installation of the fingerprint sensing device inside the electronic apparatus, especially at the side frame.

Therefore, how to reduce the size of the fingerprint sensing device to facilitate its installation inside the electronic apparatus, especially at the side frame, has become an urgent problem to be solved.

### SUMMARY

This section provides a general summary of the disclosure and is not a comprehensive disclosure of the full scope or all features of the disclosure.

The purpose of the disclosure is to provide a fingerprint sensing device using ultrasonic fingerprint recognition technology that can be reduced in size to facilitate its installation inside an electronic apparatus, especially at a side frame, and an electronic apparatus including such a fingerprint sensing device.

In order to achieve the above purpose, according to one aspect of the disclosure, a fingerprint sensing device is provided, which includes: a substrate, including a first surface and a second surface that are opposite to each other; a piezoelectric transducer, disposed on the first surface of the substrate; and a circuit board, disposed opposite to the piezoelectric transducer in a short side direction of the substrate. The circuit board is electrically connected to the first surface of the substrate by wire bonding, and a distance between the circuit board and the piezoelectric transducer is less than 2 mm.

In some embodiments, a piezoelectric material of the piezoelectric transducer may be polyvinylidene fluoride or polyvinylidene fluoride-trifluoroethylene copolymer.

In some embodiments, the circuit board may not overlap the substrate when viewed in a direction perpendicular to the first surface.

In some embodiments, the circuit board may be disposed on the first surface of the substrate.

In some embodiments, the distance between the circuit board and the piezoelectric transducer may be less than or equal to 1 mm.

In some embodiments, the distance between the circuit board and the piezoelectric transducer may be less than or equal to 0.5 mm.

In some embodiments, a portion of the circuit board disposed on the first surface may include a first portion. The first portion is connected to a side of the first surface extending along a long side direction of the substrate.

In some embodiments, the portion of the circuit board may further include a second portion. The second portion is connected to a side of the first surface extending along the short side direction of the substrate, and extends from the first portion along the short side direction of the substrate.

In some embodiments, the first portion may be connected to the first surface through fixing glue, and a length of the first portion in the short side direction of the substrate may be less than 1 mm.

In some embodiments, the fingerprint sensing device can be configured to sense a fingerprint at a side frame of an electronic apparatus. The piezoelectric transducer of the fingerprint sensing device sends and receives an ultrasonic signal toward the side frame.

In some embodiments, a length of the substrate in its short side direction may be less than or equal to 4 mm.

In some embodiments, the fingerprint sensing device may further include a connection layer. The connection layer is disposed on the second surface of the substrate and configured to connect the substrate to the side frame of the electronic apparatus.

In some embodiments, the connection layer may be an adhesive layer.

According to another aspect of the disclosure, an electronic apparatus is provided, which includes: a side frame, including a seating portion configured to dispose a fingerprint sensing device; and the fingerprint sensing device, which is the fingerprint sensing device described in the above aspect, and is disposed at the seating portion of the side frame and arranged such that a piezoelectric transducer is configured to send and receive an ultrasonic signal toward the side frame.

In some embodiments, the seating portion may be a recess disposed on an inner surface of the side frame, and the fingerprint sensing device is fixed in the recess.

In some embodiments, the seating portion may be a mechanical button disposed at an outer surface of the side frame, and the fingerprint sensing device is fixed to a surface of the mechanical button located at an inner side of the side frame.

In some embodiments, a first surface or a second surface of the substrate may be connected to a bottom surface of the seating portion.

In some embodiments, the substrate may be connected to the bottom surface of the seating portion through a connection layer disposed on the second surface.

In some embodiments, the bottom surface of the seating portion may be flat.

In some embodiments, a roughness of the bottom surface of the seating portion may be less than 1/10 of a wavelength of an ultrasonic wave sent by the piezoelectric transducer.

In some embodiments, a roughness of a portion of the outer surface of the side frame corresponding to the bottom surface of the seating portion may be less than 1/10 of the wavelength of the ultrasonic wave sent by the piezoelectric transducer.

In some embodiments, a distance between the bottom surface of the seating portion and the outer surface of the side frame in a direction perpendicular to the bottom surface may be within a range of 0.5 mm to 1.5 mm.

In some embodiments, the seating portion may have a shape of a rectangle, and an aspect ratio of the rectangle may be greater than or equal to 2.

According to the above technical solution, by electrically connecting the circuit board to the first surface of the substrate through wire bonding, and by shortening the distance between the circuit board and the piezoelectric transducer on the substrate accordingly, it is possible that the length of the fingerprint sensing device in the short side direction of the substrate can be reduced while the fingerprint sensing device still achieves the required recognition performance, without affecting the piezoelectric effect of the piezoelectric material of the piezoelectric transducer, thereby reducing the size of the fingerprint sensing device, and facilitating the installation of the fingerprint sensing device inside the electronic device, especially at the side frame.

### BRIEF DESCRIPTION OF THE DRAWINGS

Features and advantages of embodiments of the disclosure will become more readily understood from the following description with reference to the accompanying drawings. The drawings are not drawn to scale and some features may be exaggerated or reduced to show details of particular components. In the accompanying drawings:

FIG. 1 is a schematic perspective view of a fingerprint sensing device in the related art;

FIG. 2 is a schematic cross-sectional view of the fingerprint sensing device shown in FIG. 1 taken along a line L-L′;

FIG. 3 is a schematic perspective view of a fingerprint sensing device according to an embodiment of the disclosure;

FIG. 4 is a schematic cross-sectional view of the fingerprint sensing device shown in FIG. 3 taken along a line A-A′;

FIG. 5 is a schematic cross-sectional view of the fingerprint sensing device shown in FIG. 3 taken along a line B-B′;

FIG. 6 is a schematic perspective view of a fingerprint sensing device according to another embodiment of the disclosure;

FIG. 7 is a schematic cross-sectional view of the fingerprint sensing device shown in FIG. 6 taken along a line C-C′;

FIG. 8 is a fingerprint sensing device according to still another embodiment of the disclosure in a schematic cross-sectional view similar to FIG. 4;

FIG. 9 is a partial schematic view of a fingerprint sensing device connected to a side frame of an electronic apparatus according to an embodiment of the disclosure;

FIG. 10 is a schematic perspective view of an electronic apparatus with a seating portion that is a recess;

FIG. 11 is a partial schematic view of a fingerprint sensing device being disposed at a seating portion that is a recess; and

FIG. 12 is a partial schematic view of a fingerprint sensing device being disposed at a seating portion that is a mechanical button.

In the drawings, the same or similar technical features or components are denoted by the same or similar referential numerals.

### DESCRIPTION OF THE EMBODIMENTS

The disclosure is described in detail below with the aid of exemplary embodiments with reference to the accompanying drawings. It should be noted that the following detailed description of the disclosure is only used to illustrate and rather than to limit the disclosure.

It should be noted that, for the sake of clarity, not all features of specific embodiments are described and shown in the specification and the drawings, and to avoid unnecessary details obscuring the technical solutions focused on in the disclosure, in the specification and the drawings, only the device structure closely related to the technical solution of the disclosure is described and shown, and other details that are not closely related to the technical content of the disclosure and are known to those skilled in the art are omitted.

As mentioned previously, due to the limited internal space of the electronic apparatus, in order to facilitate the installation of the fingerprint sensing device using the ultrasonic fingerprint recognition technology inside the electronic apparatus, the size of the fingerprint sensing device needs to be reduced. A detailed description will be given below in conjunction with an ultrasonic fingerprint sensing device according to the related art.

It should be noted that the ultrasonic fingerprint sensing device described here according to the related art does not necessarily fall within the scope of the prior art.

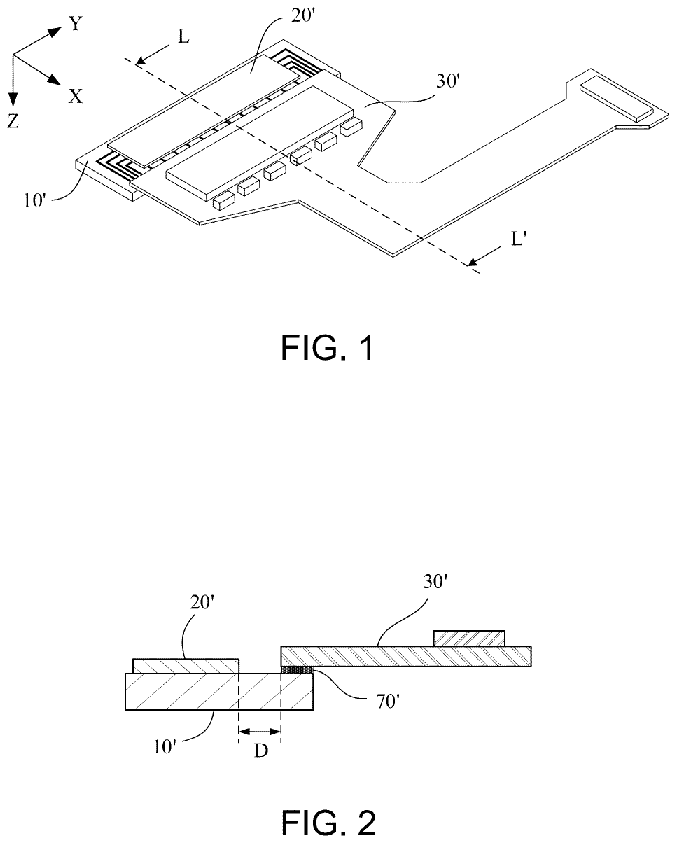

First, referring to FIG. 1, an ultrasonic fingerprint sensing device 1′ according to the related art is shown.

The ultrasonic fingerprint sensing device 1′ includes a sensor chip and a circuit board 30′. The sensor chip includes a substrate 10′ and a piezoelectric transducer 20′ disposed on the substrate 10′. The piezoelectric transducer 20′ is configured to send an ultrasonic signal based on a piezoelectric effect of a piezoelectric material and receive an ultrasonic signal reflected back by the detected fingerprint of a finger. The piezoelectric material of the piezoelectric transducer 20′ is usually polyvinylidene fluoride (PVDF) or polyvinylidene fluoride-trifluoroethylene copolymer (PVDF-TrFE), or can be other piezoelectric materials commonly used here. The circuit board 30′ is electrically connected to the substrate 10′ by anisotropic conductive film (ACF) bonding to achieve electrical signal transmission between the sensor chip and the circuit board 30′.

As shown in FIG. 1, the size of the ultrasonic fingerprint sensing device 1′ includes its length in an X-axis direction shown in FIG. 1, its length in a Y-axis direction perpendicular to the X-axis direction, and its length in a Z-axis direction that is perpendicular to both the X-axis direction and the Y-axis direction. It can be observed that, taking the substrate 10′ having a shape of a rectangle shown in FIG. 1 as an example, the X-axis direction indicates a short side direction of the substrate 10′, the Y-axis direction indicates a long side direction of the substrate 10′, and the Z-axis direction indicates a direction perpendicular to an upper surface of the substrate 10′ (the X-axis direction, the Y-axis direction, and the Z-axis direction shown in other figures are the same as those in FIG. 1 and are not repeated below). Therefore, the size of the ultrasonic fingerprint sensing device can be reduced by reducing the length of the ultrasonic fingerprint sensing device 1′ in at least one of the X-axis direction, the Y-axis direction, and the Z-axis direction.

The inventor noticed that in the ultrasonic fingerprint sensing device, conventionally, the circuit board is electrically connected to the substrate by ACF bonding. The ACF bonding method provides both adhesive fixation and longitudinal electrical conduction between the circuit board and the substrate through the ACF. However, the process temperature of the ACF bonding is usually greater than 170° C., which will adversely affect the piezoelectric effect of the piezoelectric material of the piezoelectric transducer, making the ultrasonic fingerprint sensing device unable to achieve the required recognition performance. For this reason, when designing the ultrasonic fingerprint sensing device, the ACF bonding position is separated from the piezoelectric transducer by a certain distance to eliminate such an adverse effect.

For example, referring to FIG. 2, FIG. 2 is a cross-sectional view of the ultrasonic fingerprint sensing device 1′ shown in FIG. 1 taken along a line L-L′ parallel to the X-axis direction. As shown in FIG. 2, the circuit board 30′ is connected to the substrate 10′ in the short side direction of the substrate 10′ through an ACF 70′, and the ACF bonding position is separated from the piezoelectric transducer 20′ by a distance D in the short side direction of the substrate 10′. Typically, the distance D is greater than or equal to 2 mm. In this way, the temperature from the ACF bonding position felt by the piezoelectric transducer 20′ during the ACF bonding will be reduced because the piezoelectric transducer 20′ is away from the ACF bonding position by the distance D. Therefore, the influence of the process temperature of the ACF bonding on the piezoelectric effect of the piezoelectric material of the piezoelectric transducer 20′ can be weakened or even eliminated, so that the ultrasonic fingerprint sensing device 1′ can achieve the required recognition performance.

However, the setting of the separation distance also limits the reduction of the length of the ultrasonic fingerprint sensing device 1′ in the X-axis direction (i.e., the short side direction of the substrate 10′), and therefore the reduction of the size of the ultrasonic fingerprint sensing device 1′ is limited.

The inventors noticed the above limitations and intended to overcome them by reducing the separation distance to reduce the length of the fingerprint sensing device in the short side direction of the substrate while achieving the required recognition performance of the fingerprint sensing device, thereby achieving a reduction in the size of the fingerprint sensing device.

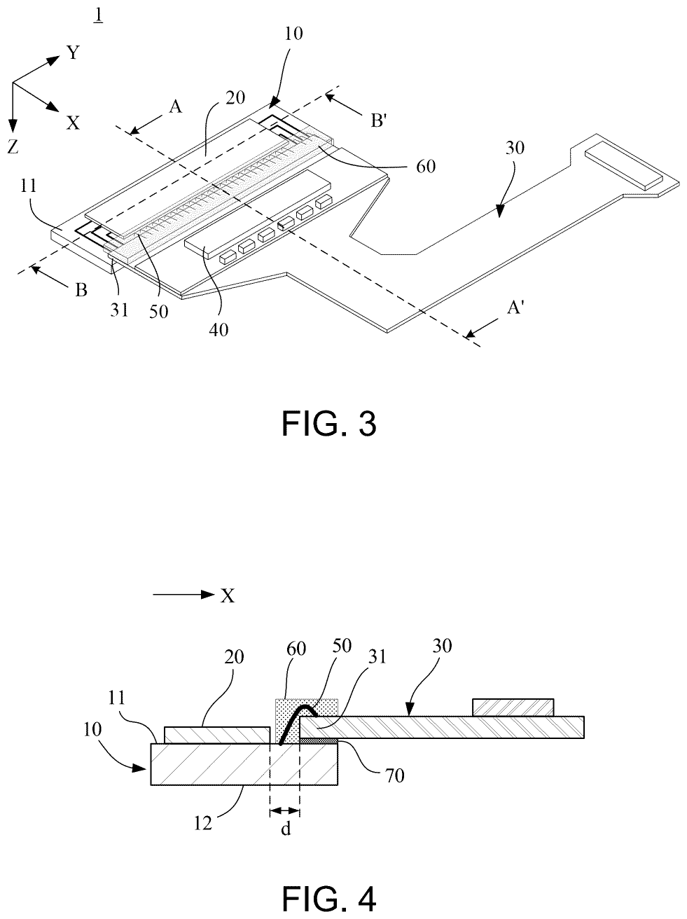

Specifically, referring to FIG. 3 to FIG. 5, according to embodiments of the disclosure, a fingerprint sensing device 1 is provided.

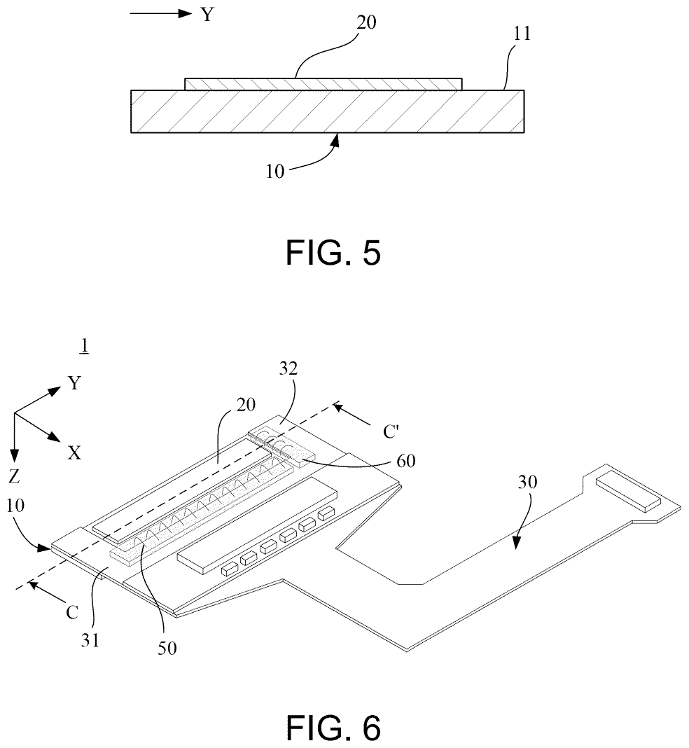

FIG. 4 is a cross-sectional view of the fingerprint sensing device 1 shown in FIG. 3 taken along a line A-A′ parallel to the X-axis direction, and FIG. 5 is a cross-sectional view of the fingerprint sensing device 1 shown in FIG. 3 taken along a line B-B′ parallel to the Y-axis direction.

The fingerprint sensing device 1 includes a substrate 10, a piezoelectric transducer 20, and a circuit board 30.

The substrate 10 includes a first surface 11 and a second surface 12 that are opposite to each other, that is, an upper surface and a lower surface facing away from each other in the Z-axis direction, as shown in FIG. 4 and FIG. 5. The substrate 10 generally has a shape of a rectangle, such as that shown in FIG. 3, but it will be understood that it may also be in other shapes. In addition, the substrate 10 may be a glass substrate or a substrate made of other materials, such as a silicon substrate.

The piezoelectric transducer 20 is disposed on the first surface 11 of the substrate 10. Typically, the piezoelectric transducer includes a piezoelectric material layer and two electrode layers respectively disposed on two opposite sides of the piezoelectric material layer. Based on the inverse piezoelectric effect, when the electrode layer receives a driving signal, it will trigger the vibration of the piezoelectric material layer to generate the ultrasonic signal. On the other hand, when the piezoelectric material layer receives the ultrasonic signal reflected back by the finger, it will expand and contract. Based on the positive piezoelectric effect, a potential difference will be formed between the electrode layers to generate a fingerprint electrical signal, which will eventually be processed to obtain a fingerprint pattern.

The circuit board 30 and the piezoelectric transducer 20 are disposed opposite to each other in the short side direction of the substrate 10. That is, the circuit board 30 and the piezoelectric transducer 20 face each other in the short side direction of the substrate 10 (that is, the X-axis direction). For example, as shown in FIG. 4, the left end of the circuit board 30 is opposite the right end of the piezoelectric transducer 20.

In the case shown in FIG. 4, the circuit board 30 and the piezoelectric transducer 20 are both located on the first surface 11 of the substrate 10 and disposed opposite to each other in the short side direction of the substrate 10. However, it is conceivable that the circuit board may not be disposed on the substrate, but the circuit board may still be disposed opposite to the piezoelectric transducer in the short side direction of the substrate.

In this way, the circuit board 30 and the piezoelectric transducer 20 do not overlap when viewed along the Z-axis direction. In this manner, the circuit board 30 generally does not affect the transmission of the ultrasonic signal sent by the piezoelectric transducer 20 and the reflected ultrasonic signal to be received by the piezoelectric transducer 20. At the same time, a thickness of the fingerprint sensing device can be smaller, which is advantageous for its arrangement in the limited internal space.

The circuit board 30 may be a printed circuit board (PCB), a flexible printed circuit (FPC), or any other suitable type of circuit board. The circuit board 30 can send the detected fingerprint electrical signal to other components such as an application specific integrated circuit (ASIC) 40 shown in FIG. 3 for processing through electrical connection with the substrate 10.

In the embodiment, as shown in FIG. 3 and FIG. 4, the circuit board 30 is electrically connected to the first surface 11 of the substrate 10 by wire bonding, and the distance d between the circuit board 30 and the piezoelectric transducer 20 is less than 2 mm.

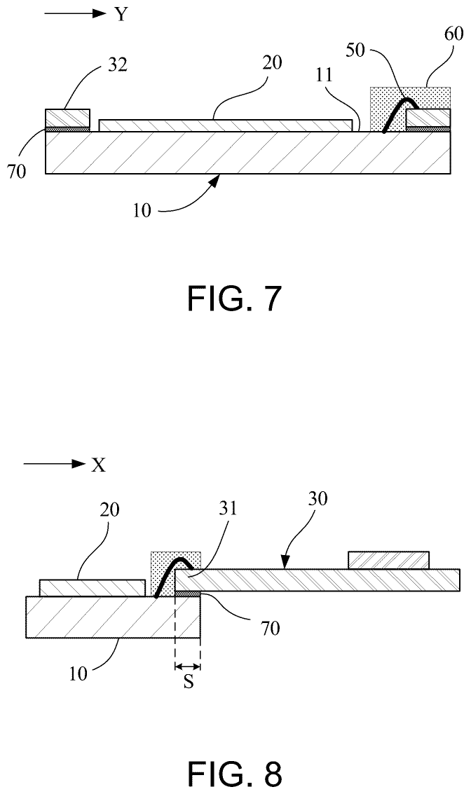

That is to say, the circuit board 30 and the first surface 11 of the substrate 10 are electrically connected to each other through a wire 50 instead of the commonly used ACF bonding method. For example, one end of the wire 50 may be connected to a soldering pad (not shown) on the circuit board 30 and the other end may be connected to a soldering pad (not shown) on the first surface 11 of the substrate 10. Additionally, the wire and the wire bonding position may have protective glue 60 applied to protect the wire bonding area. For the sake of clarity, in FIG. 3 and FIG. 4 as well as FIG. 6 and FIG. 7 to be mentioned below, the wire is shown to be visible through the protective glue 60.

The inventor noticed that the process temperature of the wire bonding is less than the process temperature of the ACF bonding, and generally does not affect the piezoelectric effect of the piezoelectric material of the piezoelectric transducer 20. Based on this finding, in the embodiment of the disclosure, by electrically connecting the circuit board 30 to the first surface 11 of the substrate 10 by wire bonding, and by reducing the separation distance d between the circuit board 30 and the piezoelectric transducer 20, the length of the fingerprint sensing device 1 in the short side direction of the substrate 10 can be reduced without affecting the recognition performance of the fingerprint sensing device 1, thereby reducing the size of the fingerprint sensing device 1. That is, in the case where the circuit board 30 is electrically connected to the first surface 11 of the substrate 10 by wire bonding, by making the distance d between the circuit board 30 and the piezoelectric transducer 20 at least less than the distance D in the case of the ACF bonding shown in FIG. 1, that is, making d be less than 2 mm, the reduction in the length of the fingerprint sensing device 1 in the short side direction of the substrate 10 can be achieved, thereby reducing the size of the fingerprint sensing device 1.

Further, by reducing the size of the fingerprint sensing device, it can bring benefits to the installation of the fingerprint sensing device in the limited internal space of the electronic apparatus. For example, the fingerprint sensing device can be installed more easily in the electronic apparatus, and the space reserved by the electronic apparatus for the installation of the fingerprint sensing device can be reduced, thereby bringing more possibilities to the overall or partial space design of the electronic apparatus.

It can be understood that since the process temperature of the wire bonding will not affect the piezoelectric effect of the piezoelectric material of the piezoelectric transducer 20, the distance d between the circuit board 30 and the piezoelectric transducer 20 can actually be smaller.

When the circuit board 30 is electrically connected to the first surface 11 of the substrate 10 through the wire 50, the circuit board 30 no longer needs to be bonded and fixed on the first surface 11 through the ACF to achieve electrical connection with the substrate 10. At this time, based on the structural design or structural strength considerations of the fingerprint sensing device, the circuit board and the substrate can be disposed side by side. That is to say, the circuit board can be prevented from overlapping the substrate when viewed in a direction perpendicular to the first surface of the substrate (i.e., the Z-axis direction).

However, it is also conceivable that the circuit board 30 is disposed on the first surface 11 of the substrate 10 as shown in FIG. 3 and FIG. 4.

From the distance between the circuit board and the piezoelectric transducer, when the circuit board and the substrate are disposed side by side, this distance will include the separation distance between the circuit board and the substrate in the X-axis direction. Even if the two opposite ends of the circuit board and the substrate are disposed immediately adjacent to each other, for example, if the left end of the circuit board is disposed immediately adjacent to the right end of the substrate, this distance will also include the unavoidable manufacturing gap between the two ends (usually around 0.5 mm).

By disposing the circuit board 30 on the first surface 11, compared with disposing the circuit board and the substrate side by side, the separation distance and the manufacturing gap can be omitted, thereby reducing the distance between the circuit board and the piezoelectric transducer, and reducing the length of the fingerprint sensing device in the X-axis direction.

In the case where the circuit board 30 is disposed on the first surface 11 of the substrate 10, based on the current level of the wire bonding process, the distance d between the circuit board 30 and the piezoelectric transducer 20 can be made less than or equal to 1 mm, and more preferably, less than or equal to 0.5 mm.

Therefore, compared with the distance D between the circuit board and the piezoelectric transducer in the case of the ACF bonding, the separation distance d between the circuit board 30 and the piezoelectric transducer 20 is significantly reduced, and due to the length of the fingerprint sensing device 1 in the X-axis direction being significantly reduced, the fingerprint sensing device 1 can be applied to situations where size requirements are more stringent.

For example, it is conceivable that in the context that the space reserved for the installation of the fingerprint sensing device inside the electronic apparatus, especially a mobile phone, is usually only a few millimeters, such as when the fingerprint sensing device is disposed on the side frame, the significant reduction in the length of the fingerprint sensing device in the X-axis direction will be particularly advantageous in the installation of the fingerprint sensing device. For example, it can reduce the difficulty of the installation, and improve the adaptability of the installation, and even the aesthetics of the installation area.

In some embodiments, referring to FIG. 3, FIG. 4, and FIG. 6, a portion of the circuit board 30 disposed on the first surface 11 includes a first portion 31. The first portion 31 is connected to a side of the first surface 11 extending along the long side direction of the substrate 10.

For example, the first portion 31 can be connected to the side by fixing glue 70 (see FIG. 4). In the case where the first portion 31 is connected to the side of the first surface 11, the circuit board 30 can be fixed on the first surface 11 of the substrate 10, thereby making the entire fingerprint sensing device 1 have better structural stability, and reducing the possibility of damage to the electrical connection of the wire 50 as a result of the circuit board moving relative to the substrate due to some unexpected circumstances. Furthermore, by connecting the first portion 31 to the side of the first surface 11 extending along the long side direction of the substrate 10, as shown in FIG. 6, for most of the wires, i.e., the wire 50 whose electrical signal is directed to the long side of the piezoelectric transducer 20, they can be connected to the circuit board and the substrate with a relatively short length, thereby optimizing the arrangement of the wires and reducing the risk of line failure. As shown in FIG. 3, the first portion 31 extends over substantially the entire length of the first surface 11 of the substrate 10. However, it is conceivable that the first portion 31 may also extend over only a portion of this length.

In some embodiments, as shown in FIG. 6 and FIG. 7, the portion of the circuit board 30 disposed on the first surface 11 also includes a second portion 32. The second portion 32 is connected to the side of the first surface 11 extending along the short side direction of the substrate 10, and extends from the first portion 31 along the short side direction of the substrate 10.

FIG. 7 is a cross-sectional view of the fingerprint sensing device 1 shown in FIG. 6 taken along a line C-C′ parallel to the Y-axis direction.

Likewise, for example, the second portion 32 can be connected to the side through the fixing glue 70. By disposing the second portion 32, the circuit board 30 can be connected to the first surface 11 of the substrate 10 at both the first portion 31 and the second portion 32 around the piezoelectric transducer 20, thereby further enhancing the structural stability of the entire fingerprint sensing device 1.

In addition, in the case where the second portion 32 is disposed, as shown in FIG. 6, for the wire 50 whose electrical signal is directed to the short side of the piezoelectric transducer 20, its two ends may be connected to the substrate 10 and the second portion 32 of the circuit board 30, respectively. In this case, the distance between the short side of the piezoelectric transducer 20 and the second portion 32 of the circuit board 30 (hereinafter referred to as the short side distance) may be the same as the distance d and be controlled within a smaller range. Compared to the short side distance when disposing the second portion in the case of the ACF bonding, since there is no need to consider the influence of the process temperature of the ACF bonding on the piezoelectric effect of the piezoelectric material, the short side distance in the above wire bonding case can be smaller, thereby making the length of the fingerprint sensing device in the Y-axis direction relatively small.

As shown in FIG. 6 and FIG. 7, the second portion 32 includes two portions respectively connected to two sides of the first surface 11 extending along the short side direction of the substrate 10. However, it is conceivable that the second portion 32 may also include only a portion connected to a side of the first surface 11 extending along the short side direction of the substrate 10.

In some embodiments, as shown in FIG. 8, the first portion 31 is connected to the first surface 11 through the fixing glue 70, and a length S of the first portion 31 in the short side direction of the substrate 10 is less than 1 mm.

In the case of the ACF bonding method shown in FIG. 1, the circuit board 30′ is bonded and fixed on the upper surface of the substrate 10′ through the ACF 70′. In order to achieve normal electrical conduction between the circuit board 30′ and the substrate 10′ through the ACF 70′, the length of the ACF 70′ in the short side direction of the substrate 10′ generally must be greater than 1 mm.

However, where wire bonding is configured to electrically connect the circuit board to the substrate, the ACF is no longer required. In this case, when using the fixing glue to connect the circuit board to the first surface of the substrate, there is no need to consider the electrical conduction effect, so that, as shown in FIG. 8, the length S of the first portion 31 in the short side direction of the substrate 10 can be reduced, for example, to less than 1 mm, while still achieving a fixed connection effect, compared to the case of the ACF bonding method. In this way, since the length of the position reserved for connecting the first portion 31 on the first surface 11 of the substrate 10 is reduced, it is possible to reduce the width of the substrate 10, thereby reducing the size of the fingerprint sensing device 1.

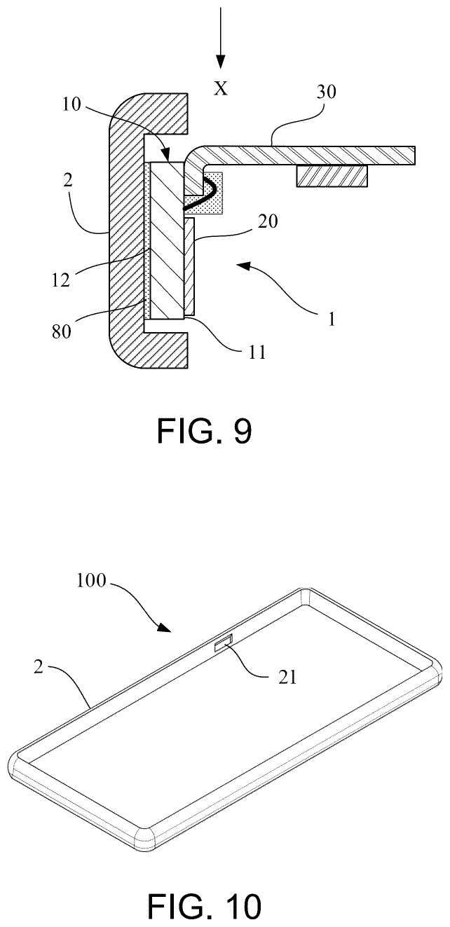

In the case where the size of the fingerprint sensing device 1 is reduced in the above manner, as mentioned above, the fingerprint sensing device 1 can be applied to situations where size requirements are more stringent. For example, as shown in FIG. 9, the fingerprint sensing device 1 can be configured to sense a fingerprint at a side frame 2 of the electronic apparatus. It should be noted that, in order to facilitate a clearer explanation, FIG. 9 shows a side frame of the electronic apparatus in a partial view, where the up and down directions in FIG. 9 are perpendicular to the front of the electronic apparatus.

In this case, the piezoelectric transducer 20 of the fingerprint sensing device 1 sends and receives the ultrasonic signal toward the side frame 2. That is to say, in this case, the fingerprint sensing device 1 will be disposed in the electronic apparatus such that the first surface 11 or the second surface 12 of the substrate 10 faces the side frame 2 of the electronic apparatus. Therefore, the piezoelectric transducer 20 disposed on the first surface 11 of the substrate 10 can send and receive the ultrasonic signal toward the side frame 2 to achieve fingerprint recognition at the side frame 2.

It can be understood that no matter whether the fingerprint sensing device 1 is installed with the first surface 11 facing the side frame 2 or the second surface 12 facing the side frame 2, the piezoelectric transducer 20 can normally send the ultrasonic signal to the side frame 2 and receive the ultrasonic signal reflected back by the fingerprint of the finger to achieve fingerprint recognition.

Generally, as shown in FIG. 9, the fingerprint sensing device 1 is installed at the side frame 2 of the electronic apparatus such as a mobile phone, and the short side direction of the substrate 10 is substantially perpendicular to the front of the electronic apparatus.

When the distance between the circuit board 30 and the piezoelectric transducer 20 is less than or equal to 1 mm or less than or equal to 0.5 mm, the length of the substrate 10 in its short side direction (i.e., the width of the substrate) can be less than or equal to 4 mm. Since FPC is usually used in side frame applications, when installed, the actual length of the fingerprint sensing device 1 in the short side direction of the substrate 10 is substantially the same as the width of the substrate 10 itself. In the current situation where electronic apparatuses such as mobile phones are being designed to become increasingly thinner, the smaller size will be very advantageous for the installation of the fingerprint sensing device on the side frame of the electronic apparatus. In comparison, in the case of the ACF bonding method shown in FIG. 1, due to the limitation of the separation distance set to eliminate the adverse effects, the width of the substrate or the actual length of the fingerprint sensing device in the short side direction of the substrate cannot be reduced to less than or equal to 4 mm.

In some embodiments, as shown in FIG. 9, the fingerprint sensing device 1 further includes a connection layer 80. The connection layer 80 is disposed on the second surface 12 of the substrate 10 and configured to connect the substrate 10 to the side frame 2 of the electronic apparatus.

The connection layer 80 is disposed on the second surface 12 of the substrate 10. The second surface 12 does not have the piezoelectric transducer 20, the wire 50, and possibly the circuit board 30 disposed thereon like the first surface 11, and therefore has a flatter surface, in which case the substrate 10 can be more reliably connected to the side frame 2 of the electronic apparatus through the connection layer 80. On the other hand, since it is the second surface 12 rather than the first surface 11 connected with the wire that is connected to the side frame 2 through the connection layer 80, when the ultrasonic signal is sent to the side frame 2 of the electronic apparatus through the piezoelectric transducer 20 and the ultrasonic signal reflected back by the fingerprint of the detected finger is received, it is possible to avoid the ultrasonic signal and prevent the recognition performance from being affected by the wire.

In some embodiments, the connection layer 80 is an adhesive layer. By bonding the second surface 12 of the substrate 10 to the side frame 2 of the electronic apparatus, a uniform connection can be obtained between the second surface 12 of the substrate 10 and the side frame 2. The uniformity of the connection facilitates the transmission of the ultrasonic signal, and thus a better recognition performance can be obtained.

Referring to FIG. 10 to FIG. 12, according to embodiments of the disclosure, an electronic apparatus 100 is also provided.

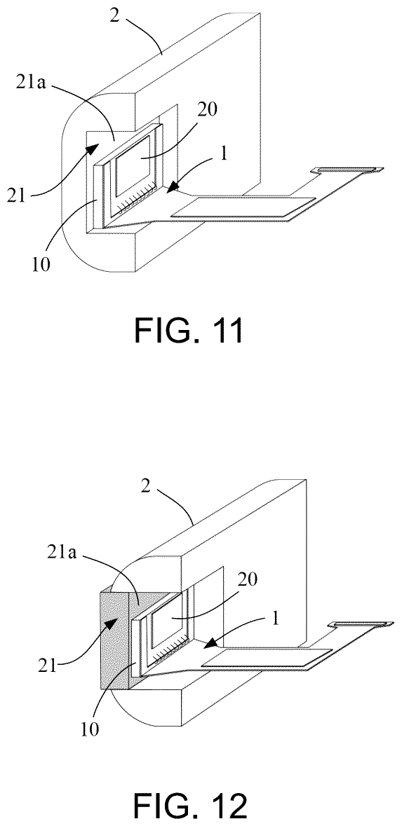

Illustratively, the electronic apparatus 100 is shown in FIG. 10 as a mobile phone. For the sake of clarity, FIG. 10 shows only the side frame of the electronic apparatus in a perspective view, and FIG. 11 and FIG. 12 both show the arrangement details of the fingerprint sensing device at the side frame in partial views.

The electronic apparatus 100 includes the side frame 2 and the fingerprint sensing device 1. The side frame 2 includes a seating portion 21 configured to dispose the fingerprint sensing device. The fingerprint sensing device 1 is disposed at the seating portion 21 of the side frame 2 and arranged such that the piezoelectric transducer 20 is configured to send and receive the ultrasonic signal toward the side frame 2.

As an example and not a limitation, the electronic apparatus may be a mobile phone, a tablet computer, a laptop computer, a vehicle-mounted electronic apparatus, a smart wearable device such as a smart watch, smart glasses, etc.

In some embodiments, as shown in FIG. 10 and FIG. 11, the seating portion 21 is a recess disposed on an inner surface of the side frame 2, and the fingerprint sensing device 1 is fixed in the recess. In this case, an area of an outer surface of the side frame 2 corresponding to the recess can form a hidden button, that is, a button without a mechanical structure. By disposing the fingerprint sensing device 1 in the recess, the internal space of the electronic apparatus can be saved and the fingerprint sensing device 1 can be prevented from being affected by other components in the electronic apparatus. At the same time, the fingerprint sensing device 1 can also be brought closer to the button area on the outer surface of the side frame 2, which is advantageous for enhancing the sensing and recognition performance.

It is conceivable that, as shown in FIG. 12, the seating portion 21 can also be a mechanical button disposed at the outer surface of the side frame 2, and the fingerprint sensing device 1 is fixed to a surface of the mechanical button located at an inner side of the side frame 2. In this way, the piezoelectric transducer of the fingerprint sensing device can still send and receive the ultrasonic signal toward the side frame to achieve fingerprint recognition.

In some embodiments, as clearly shown in FIG. 11 and FIG. 12, the first surface 11 or the second surface 12 of the substrate 10 is connected to a bottom surface 21a of the seating portion 21. In this way, there will be no air gap in the transmission path of the ultrasonic signal between the piezoelectric transducer 20 and the outer surface of the side frame 2 (an outer surface of the mechanical button in the case of a mechanical button), thereby improving the transmission efficiency of the ultrasonic signal and thus the recognition performance.

In some embodiments, the substrate 10 is connected to the bottom surface 21a of the seating portion 21 through a connection layer (such as the connection layer 80 shown in FIG. 9) disposed on the second surface 12. Similar to what was mentioned before, in this way, the substrate 10 can be more reliably connected to the seating portion 21 through the connection layer, and the ultrasonic signal and thus the recognition performance can be prevented from being affected by the wire.

In some embodiments, the bottom surface 21a of the seating portion 21 is flat. In this case, when the substrate 10 is connected to the bottom surface 21a of the seating portion 21 through the first surface 11 or the second surface 12, a stronger connection can be obtained. In particular, as mentioned before, the second surface 12 has a flatter surface due to the absence of the piezoelectric transducer, the wire, and the possible circuit board disposed thereon. In this way, when the substrate 10 is connected to the flat bottom surface 21a of the seating portion 21 through the second surface 12, the firmness of the connection can be further enhanced. In addition, since the bottom surface 21a is flat, the transmission efficiency of the ultrasonic signal can be improved, thus improving the recognition performance.

In some embodiments, a roughness of the bottom surface 21a of the seating portion 21 is less than 1/10 of a wavelength of an ultrasonic wave sent by the piezoelectric transducer 20. For example, the roughness may be 16 um. By making the roughness of the bottom surface 21a be within the above range, the bottom surface 21a will be relatively smooth, thereby reducing the impact of the bottom surface 21a on the transmission efficiency of the ultrasonic wave when the ultrasonic wave passes through, and improving the fingerprint recognition performance.

Similarly, it is conceivable that a roughness of a portion of the outer surface of the side frame 2 corresponding to the bottom surface 21a of the seating portion 21 is less than 1/10 of the wavelength of the ultrasonic wave sent by the piezoelectric transducer 20. For example, the roughness can also be 16 um. Here, the portion of the outer surface of the side frame 2 corresponding to the bottom surface 21a is the portion of the outer surface of the side frame 2 that is in contact with the finger, that is, the fingerprint sensing area of the outer surface. Similarly, by making the roughness of the portion be within the above range, the portion will be relatively smooth, thereby reducing the impact of the portion on the transmission efficiency of the ultrasonic wave when the ultrasonic wave passes through, thereby also improving the fingerprint recognition performance. It can be understood that only the roughness of the portion or only the roughness of the bottom surface 21a can be made to be within the above range, or the roughness of the two can be made to be within the above range.

In some embodiments, a distance between the bottom surface 21a of the seating portion 21 and the outer surface of the side frame 2 in a direction perpendicular to the bottom surface 21a is within a range of 0.5 mm to 1.5 mm. For example, in the case where the seating portion 21 is a recess, the distance is the distance between the bottom surface 21a of the recess and the outer surface of the side frame 2 in the direction perpendicular to the bottom surface 21a; in the case where the seating portion 21 is a mechanical button, the distance is the distance between an inner side surface of the mechanical button (i.e., the bottom surface 21a) and the outer side surface (i.e., the outer surface of the side frame 2) in the direction perpendicular to the bottom surface 21a. That is to say, the distance is the distance at which the ultrasonic signal penetrates through the side frame 2 from the bottom surface 21a of the seating portion 21 and is sent to the finger contact portion of the outer surface of the side frame 2. By making the distance be within the above range, a better signal transmission effect can be obtained when the ultrasonic wave penetrates through the side frame 2, thereby improving the fingerprint recognition performance.

In some embodiments, the seating portion 21 has a shape of a rectangle, and an aspect ratio of the rectangle is greater than or equal to 2. For example, the recess is shown in FIG. 11 as having a shape of a rectangle. When the width of the substrate or the length of the fingerprint sensing device in the short side direction of the substrate can be controlled to be smaller, the width of the seating portion 21 configured to dispose the fingerprint sensing device can be set smaller, so that when the aspect ratio of the seating portion is greater than or equal to 2, the length of the seating portion will not be too long. As a result, the button can have a better appearance.

In the disclosure, the terms “upper” and “lower” and other directional terms are used for the purpose of convenience of description only and should not be regarded as limiting. Furthermore, while the disclosure has been described with reference to the exemplary embodiments, it is to be understood that the disclosure is not limited to the specific embodiments described and illustrated in detail herein. Various changes may be made to the exemplary embodiments by those skilled in the art without departing from the scope of the disclosure as defined by the claims.

Features mentioned and/or illustrated in the above description of the exemplary embodiments of the disclosure may be incorporated in one or more other embodiments in the same or similar manner, and combined with features in other embodiments or substituted in place of corresponding features in other embodiments. These technical solutions obtained through combination or substitution should also be deemed to be included in the protection scope of the disclosure.

What is claimed is:

1. A fingerprint sensing device, comprising:
a substrate, comprising a first surface and a second surface that are opposite to each other;
a piezoelectric transducer, disposed on the first surface of the substrate; and
a circuit board, disposed opposite to the piezoelectric transducer in a short side direction of the substrate,
wherein the circuit board is electrically connected to the first surface of the substrate by wire bonding, and a distance between the circuit board and the piezoelectric transducer is less than 2 mm.

2. The fingerprint sensing device according to claim 1, wherein a piezoelectric material of the piezoelectric transducer is polyvinylidene fluoride or polyvinylidene fluoride-trifluoroethylene copolymer.

3. The fingerprint sensing device according to claim 1, wherein the circuit board does not overlap the substrate when viewed in a direction perpendicular to the first surface.

4. The fingerprint sensing device according to claim 1, wherein the circuit board is disposed on the first surface of the substrate.

5. The fingerprint sensing device according to claim 4, wherein the distance between the circuit board and the piezoelectric transducer is less than or equal to 1 mm.

6. The fingerprint sensing device according to claim 4, wherein the distance between the circuit board and the piezoelectric transducer is less than or equal to 0.5 mm.

7. The fingerprint sensing device according to claim 4, wherein a portion of the circuit board disposed on the first surface comprises a first portion, and the first portion is connected to a side of the first surface extending along a long side direction of the substrate.

8. The fingerprint sensing device according to claim 7, wherein the portion of the circuit board further comprises a second portion, and the second portion is connected to a side of the first surface extending along the short side direction of the substrate, and extends from the first portion along the short side direction of the substrate.

9. The fingerprint sensing device according to claim 7, wherein the first portion is connected to the first surface through fixing glue, and a length of the first portion in the short side direction of the substrate is less than 1 mm.

10. The fingerprint sensing device according to claim 5, wherein the fingerprint sensing device is configured to sense a fingerprint at a side frame of an electronic apparatus, and the piezoelectric transducer of the fingerprint sensing device sends and receives an ultrasonic signal toward the side frame.

11. The fingerprint sensing device according to claim 6, wherein the fingerprint sensing device is configured to sense a fingerprint at a side frame of an electronic apparatus, and the piezoelectric transducer of the fingerprint sensing device sends and receives an ultrasonic signal toward the side frame.

12. The fingerprint sensing device according to claim 10, wherein a length of the substrate in the short side direction thereof is less than or equal to 4 mm.

13. The fingerprint sensing device according to claim 10, further comprising a connection layer, wherein the connection layer is disposed on the second surface of the substrate, and configured to connect the substrate to the side frame of the electronic apparatus.

14. The fingerprint sensing device according to claim 12, wherein the connection layer is an adhesive layer.

15. An electronic apparatus, comprising:
a side frame, comprising a seating portion configured to dispose a fingerprint sensing device; and
the fingerprint sensing device, wherein the fingerprint sensing device is the fingerprint sensing device according to claim 1, and the fingerprint sensing device is disposed at the seating portion of the side frame, and arranged such that a piezoelectric transducer is configured to send and receive an ultrasonic signal toward the side frame.

16. The electronic apparatus according to claim 14, wherein the seating portion is a recess disposed on an inner surface of the side frame, and the fingerprint sensing device is fixed in the recess.

17. The electronic apparatus according to claim 14, wherein the seating portion is a mechanical button disposed on an outer surface of the side frame, and the fingerprint sensing device is fixed to a surface of the mechanical button located at an inner side of the side frame.

18. The electronic apparatus according to claim 16, wherein a first surface or a second surface of a substrate is connected to a bottom surface of the seating portion.

19. The electronic apparatus according to claim 17, wherein a first surface or a second surface of a substrate is connected to a bottom surface of the seating portion.

20. The electronic apparatus according to claim 16, wherein a substrate is connected to a bottom surface of the seating portion through a connection layer disposed on a second surface.

21. The electronic apparatus according to claim 17, wherein a substrate is connected to a bottom surface of the seating portion through a connection layer disposed on a second surface.

22. The electronic apparatus according to claim 18, wherein the bottom surface of the seating portion is flat.

23. The electronic apparatus according to claim 16, wherein a roughness of a bottom surface of the seating portion is less than 1/10 of a wavelength of an ultrasonic wave sent by the piezoelectric transducer.

24. The electronic apparatus according to claim 17, wherein a roughness of a bottom surface of the seating portion is less than 1/10 of a wavelength of an ultrasonic wave sent by the piezoelectric transducer.

25. The electronic apparatus according to claim 16, wherein a roughness of a portion of the outer surface of the side frame corresponding to a bottom surface of the seating portion is less than 1/10 of a wavelength of an ultrasonic wave sent by the piezoelectric transducer.

26. The electronic apparatus according to claim 17, wherein a roughness of a portion of the outer surface of the side frame corresponding to a bottom surface of the seating portion is less than 1/10 of a wavelength of an ultrasonic wave sent by the piezoelectric transducer.

27. The electronic apparatus according to claim 16, wherein a distance between a bottom surface of the seating portion and the outer surface of the side frame in a direction perpendicular to the bottom surface is within a range of 0.5 mm to 1.5 mm.

28. The electronic apparatus according to claim 17, wherein a distance between a bottom surface of the seating portion and the outer surface of the side frame in a direction perpendicular to the bottom surface is within a range of 0.5 mm to 1.5 mm.

29. The electronic apparatus according to claim 16, wherein the seating portion has a shape of a rectangle, and an aspect ratio of the rectangle is greater than or equal to 2.

30. The electronic apparatus according to claim 17, wherein the seating portion has a shape of a rectangle, and an aspect ratio of the rectangle is greater than or equal to 2.
